(19) United States
(12) Patent Application Publication
(10) Pub. No.: US 2004/0059655 A1
(43) Pub. Date: Mar. 25, 2004

(54) Optimization method and system

(76) Inventors: Benedict Seifert, Marlow (GB); Karen Ann Croxson, Oxford (GB)

Correspondence Address: BOZICEVIC, FIELD & FRANCIS LLP, 200 MIDDLEFIELD RD, SUITE 200, MENLO PARK, CA, 94025, US

(21) Appl. No.: 10/380,490

(22) PCT Filed: Sep. 14, 2001
(86) PCT No.: PCT/EP01/10676

(30) Foreign Application Priority Data
Sep. 15, 2000 (GB) 0022736.3

(51) Int. Cl. G06F 17/60

(52) U.S. Cl. 705/35

(57) ABSTRACT

An optimization method comprises specifying an event; defining a set of outcomes for said event; defining at least one function representing a transaction between an exchange and another party, said at least one function being dependent on the outcome of said event; receiving, at said exchange, orders for at least one said transaction from at least one other party; constructing a map between the space defined by said at least one function and the space defining the proportion to which each received order is to be accepted; defining a hedging condition representing the maximum risk to which the exchange is to be exposed, using said map; defining at least one optimization criterion; calculating a solution for the values of the coefficients representing the proportions of each order to be accepted, subject to said hedging condition and said optimization criterion.

The present invention relates to a method and system for a central “exchange” or “house” that receives orders (or offers) from a set of users (or punters or gamblers), and which attempts to optimize some overall quantity (such as a resource provided over a spatial and/or temporal space, or cost or winnings or financial profit or business volume) subject to a certain set of independent constraints (such as energy available at certain times in the future, or limiting losses under certain outcomes of an event). Preferably, the exchange receives the orders over a computer network and the optimization is performed interactively in real time.

In each such system, it is open to the exchange to accept the orders from users to a greater or lesser extent, and this is the (multi-dimensional) variable the exchange is able to control. The users are free to submit and withdraw orders in real time as suits their own ‘purpose’, where purpose here means either an intent (for instance in the case of gamblers placing betting orders) or some mechanically controlled process (such as a set of processors in a distributed computing system that simply ‘order’ or offer processing power to a central computing device to the extent that is available or will be available as a function of its other operation or expected operation).

The exchange will use a central processor to do certain calculations to solve the optimization problem in real time, then accept the orders either fully or partially, communicate the result to the users. Thus, a real time iterative system for continuous optimization by the exchange operates in continuous communication between the exchange and users. The operation of the exchange is entirely controlled by the central computing device that performs all operations of optimization and communication and may be linked to automated execution services linked to the process being automated (such as settlement of bets in one application, or the mechanical control of the provision of some physical asset, such as in power stations, lighting systems, cooling systems, distributed computers, etc.).

Specific examples of such a system arise in the case of an exchange which receives orders for bets, and which determines how to operate the exchange in such a way that, for example, either it is not exposed to risk of loss at all, or it is not exposed to risk of loss in excess of a predetermined amount. There is a considerable market for offering gambling services, and there has been much interest recently, particularly on the Internet, in offering gambling services on-line. One party acts as an exchange, known in some contexts as the “house” or “bookmaker”, which offers bets with particular odds; other parties are clients of the exchange, and may variously be referred to as “gamblers”, “punters” or “bettors”, and submit bets in the hope of material gain. In an ideal situation, effectively the different bettors are betting against each other rather than against the exchange, the exchange merely acts literally as an “exchange” which matches corresponding incoming bets, and by appropriately selecting the bets on offer and the odds (which may vary as a function of time) the exchange generates some income for itself. To stay in business the exchange must not make a loss.

The same considerations apply in many other fields of engineering, for example in the allocation of resources such as CPU time in a computer, input/output bandwidth in a computer, electromagnetic spectrum bandwidth in a broadcasting system such as a mobile telephone network, charging for airtime in a communications network, sourcing and distribution of a resource such as electricity, water or gas by a utility company.

By way of example, various electricity generator companies may be able to supply amounts of power which are dependent on time of day, other demands, and geographical considerations. A distribution company acts as an exchange and delivers power to end-users. The distribution company is typically obliged (by contract, regulation or legislation) to provide continuity of supply to end-users so it must never be short of power (in the same way as the gambling house should not make a loss), whereas each of the generators hopes to offer power so that it will make a good income overall (analogous to winning a bet), but may accept the risk that occasionally their power is not required (analogous to losing a bet) in which case there is overcapacity and lower efficiency. Similarly, the end-user may, according to certain tariffs, accept a risk that occasionally it may be cut-off (lose a bet), for example have a temporary interruption to electricity supply or for example not be able to make mobile telephone calls in a cellular network.

Thus the term “bet” used herein is to be construed broadly and, for example, can mean a transaction dependent on the outcome of a specified event, and it is not limited to a particular field of use such as gambling.

In another type of application to which this invention applies, the “house” or exchange will mean any entity that will provide some service to a number of “outcomes”. For instance, the house might be a provider of lighting, or energy, or any other asset, such as the lighting system for a football stadium, a street, bridge, building, airport or any other structure that can be specifically described in ways that can be coded by a computer. The outcomes, in this example, might represent parts of the stadium, building, etc, at particular points in time or time intervals. For instance, they might represent different runways of an airport, different sections of a stadium, different hallways of a building, etc., with lighting requirements that change with time, such as time of day, season or simply number of days in the future. Thus, the set of outcomes are defined “in space time”. Specifically, for instance, the set of outcomes might be particular regions of a spatial entity, at 48 hourly intervals from the present.

The house will then face the need of providing the asset (say lighting) for all outcomes (in all regions during all future time intervals), subject to certain minimal performance constraints. For instance, the lighting of a stadium must make sure that every region of the stadium must have minimal level of lighting. This represents the ‘hedging condition’, which takes the form:

Asset(out)≧boundary(out) (H)

i.e. Asset provided to region R during time period t must exceed some lower limit (which may depend on the outcome, for instance spatial region or time of day).

This is directly comparable to the betting exchange which needs to be hedged for all outcomes, i.e. satisfy condition (H), where ‘Asset’ means financial net position, and boundary means some maximal loss, which the house may have decided to risk for various outcomes. Normally, for the betting exchange, the house may put this boundary equal to 0 for all outcomes.

In this type of example, the users may be independent suppliers of the asset to the exchange which the latter uses to provide.

Thus, in the lighting example, the gamblers would be individual light sources, used by the house to provide lighting to “outcomes”.

Each user submits orders, which are in fact offers to provide the service within certain regions of space time. He leaves to the exchange discretion as to whether to take up that offer completely (acceptance coefficient 1) or partially (acceptance coefficient <1) or not at all (acceptance coefficient ). The gambler “wins on a certain set of outcomes”, in the sense that that gambler successfully supplies the service to those outcomes (in varying degrees). For instance, take the lighting system of a stadium. The individual stadium lights (gamblers) will be able to illuminate a section of the stadium within some predefined radius of them at certain times or time periods. The set of predefined regions (outcomes) within that radius will be the set on which this particular light will “win”. On the other outcomes the light will “lose”, which phrase must be interpreted in cost terms.

In all examples of this sort precisely the same configuration of apparatuses is required for solving the fundamental problem to which this invention addresses itself: The exchange must provide its service without incurring risk, in an optimal fashion where optimal refers, in the case of a gambling exchange, to the total volume of bets it can handle, in the case of the lighting problem,—the total cost of providing the lighting requirements to all outcomes, etc.

In order for the invention to be effective, it is necessary to be able to describe the function on outcomes represented by bets, in terms of some basic family of possible betting functions. Thus, in the lighting example, one has to be able to enumerate the possible set of individual lights in terms of the geometry of the stadium, building, etc. as functions of the geometry that describes that object. Thus, one might take a finitely dimensional space of 2-dimensional wavelets to describe the light intensity of a given point of the stadium, and then express a light in a certain position and of certain technical specification in terms of that wavelet basis. In the betting case, one needs to be able to describe a finite-dimensional family of functions on outcomes.

Clearly, the operation of such systems depends on the ability of the exchange to solve an optimization problem. However, the problems posed are considerable. For a bookmaker there is the fundamental issue of setting the odds for the outcomes of a particular event, and much human skill and judgement is used, which is not necessarily optimal. For some betting events the sheer combinatorics of the situation makes it impossible for a human to match bets in a mathematically systematic way, for example, for the ranking of 20 teams in the English Soccer Premiership there are factorial(20) possible outcomes, that is over 2 million million million permutations of the teams (approx 2.4×10¹⁸). Even having set the odds, it is not possible for the exchange to be certain that it is adequately hedged against loss, or that it's maximum risked exposure to loss is bounded by a tolerable predetermined limit. If the exchange is “over-hedged” then it is probably offering uncompetitive odds and so may lose potential business; conversely, if not hedged, the exchange may unknowingly be exposed to potentially unsustainable loss. There is also the problem that the exchange lacks a mechanism for setting odds that is objective and not affected by sentiment.

The matching or exchange problem becomes even greater as different classes of bets, other than the classic fixed-odds bets, are being considered and are becoming more popular. A selection of such classes of bets is given, with definitions, in the glossary. A single bet, such as a spread bet, can, loosely speaking, correspond to a multitude of separate bets each effectively with different “odds” for each possible outcome. The number of possible outcomes can be infinite (such as the goal difference of a soccer match), and the possible pay-out by, or income to, the exchange can be unbounded. And that is just for a single bet.

A further problem is that conventional techniques do not allow the optimization process to mix different classes or families of bets (or orders) on events whose outcomes are related, such as a fixed-odds bet that a particular team will come first in a league, and a spread bet that a particular team will finish in the top five of the league. This means that cross-hedging cannot be done which results in the limited matching that can done not being optimal and results in illiquidity of the exchange.

Finally, spread bets and more exotic bets are now being considered whose pay-out or betting functions are highly non-linear. This presents a great difficulty to the exchange attempting to optimize the matching of the bets whilst remaining hedged against loss.

The present invention aims to alleviate, at least partially, some or all of the above problems.

Accordingly, the present invention provides an optimization method comprising the steps of:

specifying an event;

defining a set of outcomes for said event;

defining at least one function representing a transaction between an exchange and another party, said at least one function being dependent on the outcome of said event;

receiving, at said exchange, orders for at least one said transaction from at least one other party;

applying a map between the space generated by the or each at least one function and the space defined by coefficients representing the proportion to which each received order is to be accepted; and

calculating a solution for the values of said coefficients, using said map, subject to a defined constraint and an optimization criterion.

The present invention further provides a system comprising:

means for specifying an event;

means for defining a set of outcomes for said event;

means for defining at least one function representing a transaction between an exchange and another party, said at least one function being dependent on the outcome of said event;

communication apparatus for receiving, at said exchange, orders for at least one said transaction from at least one other party;

processing means for applying a map between the space generated by the or each at least one function and the space defined by coefficients representing the proportion to which each received order is to be accepted; and

calculation means for calculating a solution for the values of said coefficients, using said map, subject to a defined constraint and an optimization criterion.

Embodiments of the invention will now be described, by way of example only, with reference to the accompanying drawings in which:

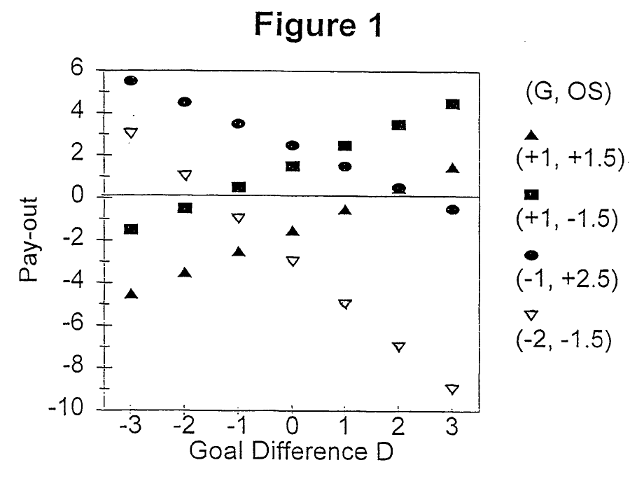

FIG. 1 is a graph plotting the pay-out or betting functions for four different examples of spread bets on the goal-difference of a match;

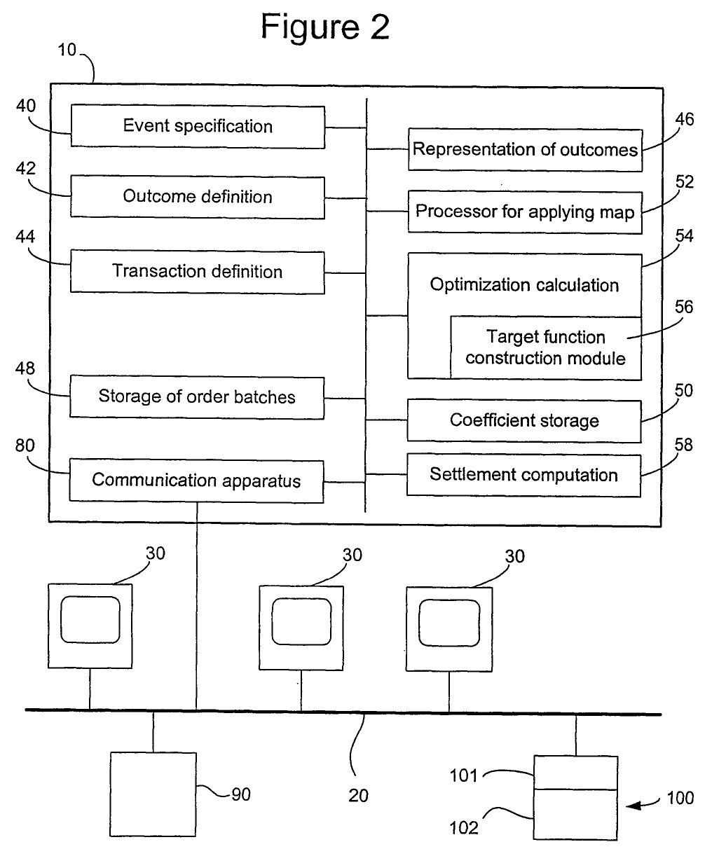

FIG. 2 is a schematic illustration of a system embodying the invention and including an exchange, a communications network and client devices;

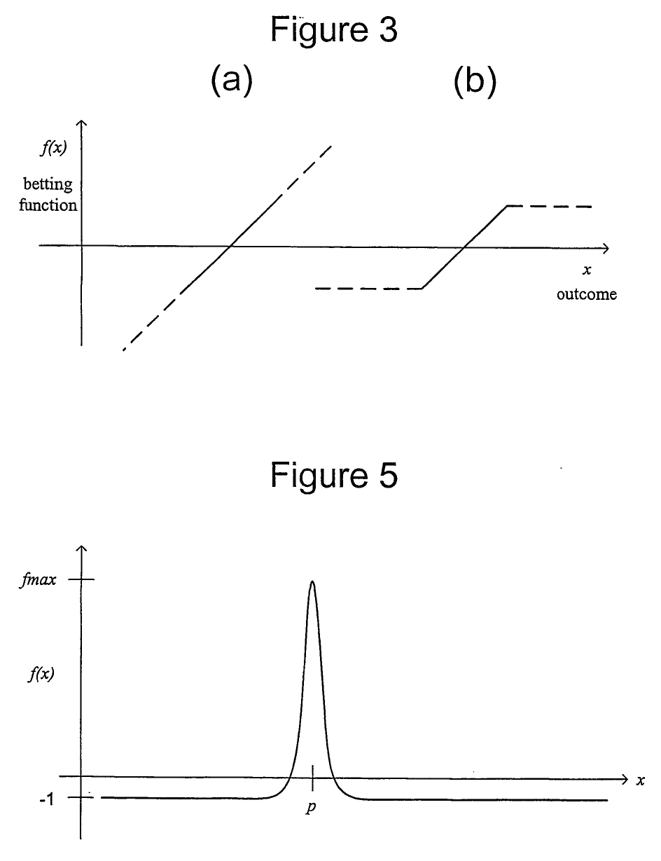

FIGS. 3(a) and (b) illustrate figuratively the betting functions of two particular types of spread bet;

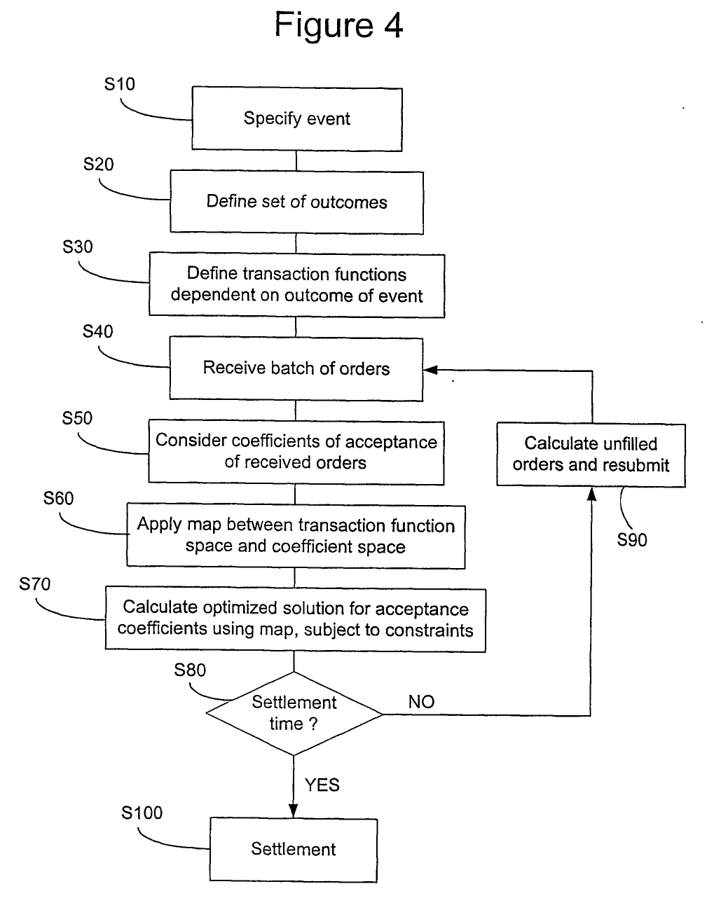

FIG. 4 is a schematic illustration of a method embodying the invention; and

FIG. 5 shows an example of a betting function for a one-dimensional continuous-odds bet.

Firstly a specific illustrative example of an application of the present invention will be described, followed by a generic description of the invention and an explanation of how it works. Further specific embodiments of the invention will then be described, with examples of some special techniques according to the invention.

For the convenience of the reader, we now set up a comparative table in which the uniform structure of the present invention, in the apparently different technical fields of the gambling exchange and the exchange providing spatially and temporally distributed assets is illustrated:

| Application to Betting | Application to Other Technologies |
|---|---|
| Typical objective: maximal volume | Typical objective: minimal total |
| or trading profit | cost |
| Punters | End suppliers of asset |
| Event space = probability space of | Event space = deterministic |
| outcomes | space/time of outcomes |
| Settlement time: At some determined | Settlement time: At one or more |
| time in the future from time the | intervals of time in the future from |
| bet is accepted | time the bet is accepted |
| Additivity: house holds -sum of | Additivity: house holds -sum of |
| individual bets | individual supplies |
| Hedging condition: bet(out) ≧ | Hedging condition: bet(out) ≧ |
| bound(out) for all outcomes | bound(out) for all space times |
| Acceptance constraint: 0 ≦ a ≦ 1 | Acceptance constraint: 0 ≦ a ≦ 1 |
| for all orders | for all orders |
| Linearisation: Outcomes are linear | Linearisation: Outcomes are linear |
| on functions | on functions |
| Communication: Betting orders and | Communication: Supply orders and |
| execution communicated in real time | execution communicated in real |
| | time |
| Optimization in real time | Optimization in real time |
| Optimization method generally uses | Optimization method generally |
| linearisation | uses linearisation |

First Specific Embodiment of the Invention

An example of an application of the present invention is to spread betting on the goal difference of a soccer match. The goal difference in a match between teams X and Y may be defined as the number of goals scored by X minus the number of goals scored by Y; the actual goal difference of a particular match will be called D. According to one form of spread betting, a bet may be placed in which an off-set (OS) and a gradient (G) are selected, such that the winnings or bet (b) for the bettor are given by the function:

b=G*D+C (1)

where C=−G*OS, so (1) can be written as: b=G*(D−OS). In other words, the bettor expects the goal difference D to exceed an off-set OS, i.e. X will score at least OS goals more than Y, and for each goal difference in excess of OS he receives a payout of G currency units (G may also be considered to be a simple scaling factor). Conversely, if X scores fewer than OS goals more than Y, the bettor must pay the exchange G for each goal that the goal difference is short of OS.

It is important to understand that both OS and G can be positive or negative real numbers. Although the goal difference D difference is always an integer (positive, negative, or zero), the value of OS does not have to be an integer. To spell out some examples, for bets with values of (G, C) as follows:

(+1, −1.5) i.e. OS=+1.5, would mean that the bettor expects X to score at least 2 goals more than Y, and e.g. he would win 0.5 currency units for a result of 2:0 (X:Y), i.e. D=+2;

(+1, +1.5) i.e. OS=−1.5, would mean that the bettor expects Y to score at most 1 goal more than X, and e.g. would win 0.5 currency units for a result of 1:2 (D=−1);

(−1, +2.5) i.e. OS=+2.5, would mean that the bettor expects X to score at most 2 goals more than Y, and e.g. would win 1.5 currency units for a result of 1:0 (D=+1); and

(−2, −3) i.e. OS=−1.5, would mean that the bettor expects Y to score at least 2 goals more than X, and would win 1 currency unit for a result of 1:3 (D=−2).

Plots of the pay-out function for the four different bets above, for a range of integer values of goal-difference D, are given in FIG. 1. In an automated betting exchange, such as one on-line, a preferred embodiment is to provide a simple user interface which enables a bettor to enter his bets in a variety of ways, and which, if necessary, will convert the bet to obtain the parameters G and OS (and hence C).

The exchange may receive many such bets on a single match, each with different values of OS and G. The winnings b for the bettor (i.e. pay-out by the exchange) for each bet are a function of G, D and OS (or C), i.e. b(G, D, C). However, the function b is not a linear function because, for a change in the outcome D by an amount δ results in the following inequality:

b(G,D,C)=G*D+C

$$\begin{matrix}b ( G , D , C = G * D + C \\ b ( G , D + δ , C ) = G * ( D + δ ) + C\end{matrix}$$

b(G,D,C)+b(G,δ,C)=G*D+C+G*δ+C

and hence:

b(G,D+δ,C)≠b(G,D,C)+b(G,δ,C).

This has made optimization of the exchange position difficult. The function b is in fact an affine function comprising a linear function plus a constant term.

According to the present invention, if n bets are received or if a batch of n bets are processed together, and each bet is accepted with a coefficient “aᵢ” which defines the proportion of the bet which the exchange chooses to accept, in the range of from 0 to 1, where 1 corresponds to accepting the amount of the bet fully, and 0 corresponds to not accepting the bet at all, the total pay-out (B) by the exchange will be:

$$\begin{matrix}B = {\sum }_{i = 1}^{n} {a}_{i} {b}_{i} \\ = {\sum }_{i = 1}^{n} {a}_{i} * ( {G}_{i} * D + {C}_{i} ) \\ = {\sum }_{i = 1}^{n} {a}_{i} {G}_{i} D + {\sum }_{i = 1}^{n} {a}_{i} {C}_{i}\end{matrix} \qquad ( 2 )$$

Once an apparatus is available for recording the functions bᵢ, and manipulating them in the usual algebraic way (i.e. adding two functions and multiplying functions by numbers) (see, for instance, Special Functions and the Theory of Group Representations, by N. Vilenkin, Paperback Revised Edition (June 1983), Amer. Mathematical Society; ISBN: 0821815725) one is able to construct a specific computational device able to store the function B in dependency on the coefficients aᵢ, simply by first multiplying the functions bᵢ by the numbers aᵢ and then adding the results to produce a function B. The process by which one arrives at the function B from the set of numbers aᵢ is, by definition, a map from the set of coefficients to the set of functions, i.e. a computational and definite rule by which the function B is constructed from the coefficients aᵢ. This map can be enshrined in a computer program outputting the value of the function B to an appropriate record in memory once the coefficients aᵢ have been recorded, assuming that the functions bᵢ are also accessible to the computer processor at the relevant time. (For a reference to the techniques of computing maps between function spaces, see Finite Dimensional Vector Spaces, by P. R. Halmos (Editor), Springer Verlag; ISBN: 0387900934, or the publication by Vilenkin referenced above.)

Hence, the steps described above for implementing this invention, in the case of the spread bets being described, can be implemented by an appropriately described computer.

The betting functions bᵢ are submitted by punters via client terminals connected to the house's (exchange's) server.

The house then uses the association (i.e. map), described and explained above, in order to set up the optimization problem which selects the coefficient aᵢ by:

First, applying the map associating an explicit expression for the betting function B to the coefficients aᵢ;

Defining the constraints expressed as conditions on B which corresponds, under the map, to the coefficients aᵢ (in addition to the constraints on the coefficients aᵢ directly);

Solving the appropriate optimization problem for the coefficients aᵢ.

We now describe this in detail:

In the last line of the above expression (2) for B, the first term is a linear form and the second term is a constant not dependent on the actual result of the soccer match (i.e. independent of the outcome of the goal-difference D). To hedge the exchange position against loss, the above expression for B must be less than or equal to zero, for all possible outcomes of the actual goal difference D, so that the exchange does not make any net pay out. This necessitates that the first term must be equal to zero, because, in principle, D can take any integer value, and therefore the only way that B can be less than or equal to zero for all outcomes is for the first term to be identically zero. This gives a first constraint on the values of aᵢ, namely

$${\sum }_{i = 1}^{n} {a}_{i} {G}_{i} = 0 \qquad ( 3 )$$

A second constraint is that the total pay-out B by the exchange should less than or equal to zero, so that the exchange never makes a loss, regardless of the outcome, i.e. B≦0, which substituting from (2) and (3) yields:

$${\sum }_{i = 1}^{n} {a}_{i} {C}_{i} \geq 0 \qquad ( 4 )$$

This is actually a conservative position on risk for the exchange to adopt, and instead, in a modification of this embodiment, it could allow B to take a positive value, but less than or equal to a predetermined maximum value, representing the maximum total payout that the exchange would have to make. This would set the upper limit on the amount which it would have to pay out, i.e. to allow some exposure to risk of loss, but bounded by a maximum amount.

Conversely, in a further modification to this embodiment, to guarantee a minimum income, the exchange could, in theory, require optimization subject to the constraint that B exceed a certain positive value; however, this would potentially reduce the competitiveness and liquidity of the exchange. These different exchange strategies do not affect the actual optimization algorithm for finding the values of aᵢ.

A further 2n constraints are that

0≦aᵢ≦1 (5)

i.e. two inequalities for each of n bets. Relation (5) represents the lower and upper limits to the degree of acceptance aᵢ of each bet, from not accepting it at all to full acceptance.

Finding the acceptance coefficients aᵢ of each bet of a batch of bets represents a constrained optimization problem. The coefficients aᵢ constitute a set of parameters defining the problem. The relations (3), (4) and (5) define constraints to which the optimization must be subject, but in general these relations do not define a unique solution, but instead whole families of values of aᵢ. Therefore the problem can be subject to one or more further optimization criteria. In the present embodiment of the invention, these criteria are defined by the exchange and are preferably that the exchange's expected revenue is maximized and that the total volume of accepted bets is maximized. Given the potentially large number of bets or orders in a batch, for example 5000, it may not be possible to find an optimal solution in a reasonable time, so sub-optimal solutions may be used which are still subject to above constraints, but which do not necessarily optimize the values specified in the criteria.

Methods and apparatus for solving the above coefficient optimization problem are disclosed in WO 99/14695, for example at page 7, line 15, to page 8, line 17, and elsewhere. The disclosure of WO 99/14695 is incorporated herein by reference in its entirety. Sources of specific algorithms for solving the optimization problem are:

N. K. Karmarkar, A new polynomial-time algorithm for linear programming. Combinatorica, 4:373-395.

C. Roos, T. Terlaky, J- Ph Vial. Theory and Algorithms for Linear Optimisation, An Interior Point Approach, J. Wiley, 1997.

B. Jansen, C. Roos, T. Terklay, J- Ph Vial, Primal-Dual Algorithms for linear programming based on the logarithmic barrier method, J. of Optimisation, Theory and Applications, 82:1-26, 1994.

R. Sedgewick, Algorithms in C++, Adison Wesley, 1992.

W. H. Press et al., Numerical Recipes in C, 2^{nd} ed. Cambridge, 1992.

General Description of Embodiments of the Invention

A more general explanation of the present invention will now be given. We use the language of betting, but our explanation will equally apply to the other technological applications described in the introduction, using the translation between the language of betting and other technology applications given in the introduction.

Referring to FIG. 2, the exchange 10 offers the service of allowing customers or bettors to submit proposals for bets on certain classes of outcomes, i.e. the bettor may offer the exchange a bet with function ƒ (see the glossary for examples of such betting functions). The exchange offers its services, for example, via an Internet web site or via a closed intranet or extranet to a given user group, in such a way that orders for bets can be entered via a keyboard, mouse, touch-sensitive screen or other input device or user interface at a user's terminal device 30 and received by a central exchange server 10 over a network 20 in real time. In the case of the Internet 20 or the like, intermediate servers (not shown), such as internet service providers, firewalls, and so on, may be present between the bettors' devices 30, the exchange server 10 and the network 20. All or part of the network 20 can be wireless, such as using a telecommunications network, with the bettor devices 30 being mobile telephones.

For a given event, the exchange considers functions on the set of outcomes (see the glossary for examples of such events, bets and outcomes). The model used by the exchange is based on considering the vector space generated by arbitrary sums and scalar products of such functions, thus forming a vector space of functions. This space will be called the betting space and will be denoted BET herein. The exchange will consider accepting bets which lie in the space BET. Each bettor places one or more orders for bets, which form a batch of bets b(1), b(2) . . . b(n) which are each in BET. When presented with an order for a bet, the exchange reserves the right to accept the order either in part or in full. The extent or proportion of each bet accepted by the house is aᵢb(i), where aᵢ is a real number between 0 and 1, inclusive, also referred to as the coefficient.

In the notation used herein, the i-th bet in a batch of bets is denoted b(i), where i is simply an index or label to identify the bet, b(i) itself is a vector in betting space. In contrast, the acceptance coefficient of the bet b(i) is denoted aᵢ, which is a scalar, and is the i-th coordinate of a vector a=(a₁, a₂, . . . aₙ), as defined later.

Many examples of betting functions are given in the Glossary, including non-linear ones as well as functions on sets without vector space structure (to which the notion of linearity does not apply). FIG. 3(a) illustrates an example of a conventional spread betting function in which the payout or revenue b=ƒ(x) increases linearly with distance of the outcome x out from some chosen off-set value. The losses or winnings are, in principle, unbounded. This can be too risky for some bettors, so another possible function is illustrated at FIG. 3(b) in which the maximum magnitude of b(out)=ƒ(x) is capped at some predetermined value. Previous techniques could not deal with such functions satisfactorily.

The exchange is prepared to simultaneously consider (and, when suitable, accept) bets of a variety of classes of bets on a given event, and consider all of them simultaneously in computing its optimal match (see Glossary). Whenever different classes of bets being accepted by the exchange relate to a correlated set of outcomes, then the methods of this invention will treat them as a whole, solving the problem of optimal execution globally. For instance, spread bets and fixed odds bets on a sports tournament will be considered together in calculating their best match. When orders for both spread bets and fixed odds bets are being considered within one batch, then the relevant betting space BET will be the vector sum of the betting spaces corresponding to fixed odds and spread bets. This is the case, for instance, for convex target functions.

In a preferred implementation of this invention, the optimization and hedging conditions (M) and (H) given below define a linear optimization problem even when the functions in BET are not linear, which is how the invention makes the problems solvable by well understood, numerically stable and precise computational methods. In fact, the hedging conditions considered in this invention are by definition linear, and the preferred choices of optimization function are also. However, this invention can also operate with non-linear optimization, or target, functions, as long as such a function, together with the linear constraint still give rise to tractable computational problems.

The invention will be further described with reference to the system illustrated in FIG. 2 and the method steps illustrated in FIG. 4. The general method of this embodiment of the invention assumes that the following are available at the outset of application of the invention:

An event, to take place in the future, has been specified 40, S10.

A mechanism 20, 80 for determining, at some point in time in the future, which of the possible outcomes of the event has occurred, is available, for instance through an automated data feed to an online web site 90 on which such data are made available in real time.

For a given event, a set of outcomes OUT for an event has been defined 42, S20.

An apparatus 44 has been constructed S30, in which a representation of a space of betting (transaction) functions, BET, is available, and for which a basis in that space has been recorded in some form.

An apparatus 46 on which a representation of all outcomes, viewed as linear functions on BET is available. (For any space of betting functions, linear or non-linear on any set or space of outcomes, the outcomes act as linear functions on BET, a fact which is known in the literature as the mathematical construction of ‘linearisation’. (see Glossary)).

An apparatus 80 for receiving from clients 30 via the Internet or other telecommunications network 20, and apparatus 48 for storing client orders, which form an order batch.

An apparatus 50 for storing an array of symbols aⱼ, corresponding to the acceptance coefficients for orders in the current order batch.

An apparatus 52 that is connected to the apparatus 50 for storing the coefficient symbols aⱼ and to the apparatus 44 for representing BET and defines a linear mapping, MAP, from the set of coefficients aⱼ to BET.

An apparatus 54 for performing certain mathematical calculations on the coefficient symbols aⱼ subject to data stored in the above apparatus 52, including data containing the current order batch, with the objective of optimizing values for the symbols aⱼ, with respect to a suitable target function, which has to be constructed in real time from the current order batch, and subject to constraints which will depend on the value of MAP(a).

Once these components are available, the general method of this embodiment of the invention comprises the following steps:

Step S40: Receiving a batch of n submitted orders for bets to be placed {b(1), b(2), . . . , b(n)}, each bet b being a function in the betting space BET.

Step S50: Considering the set A(n), the set of vectors in R(n) [the Euclidean space also denoted [symbol] ⁿ] all of whose co-ordinates lie in the closed interval between 0 and 1, each vector a in A having co-ordinates (a₁, a₂, . . . , aₙ) stored in the apparatus 50 as above.

Step S60: Using the order batch, considering the following linear map “MAP” from the space A to the betting space BET, defined as:

$$MAP ( b ( 1 ) , … b ( n ) ; {a}_{1} , … {a}_{n} ) = {\sum }_{j = 1}^{n} {a}_{j} b ( j ) .$$

This is a linear sum of bets b in BET and so always also lies in BET.

This sum represents the netted total bet with the exchange (i.e. the sum of all individual bets in the batch) that the bettors that have submitted the orders in the batch, would be taking collectively if the exchange were accepting the betting orders each to the extent indicated by the coefficient of acceptance. Thus, if it accepted the bets to these degrees, the exchange would hold minus this sum of bets. Since the invention relies on the construction of the entire betting space generated by individual bets, this sum will automatically lie in BET, and it is therefore itself a bet of the kind envisaged by the exchange. This bet held by the exchange is also referred to as the “house position”. When the actual outcome of the event is known, the evaluation of the house position function for that outcome represents the net revenue or payout by the exchange.

Step S70: Solving the optimization problem for the coefficients aⱼ defined by an optimization criterion (M), defined by a real valued function target defined on the space BET, by finding the vector a which maximises (M) subject to (H):

(M) Optimization criterion: Maximise a target function, constructed, as explained below, in a target function construction module 56, using the order batch b(1), . . . b(n)

target(b(1), . . . b(n); a₁, . . . aₙ) for a in the set A(n) defined above,

subject to the constraint condition:

(H) —MAP(a)(out) ≧con(out), for all outcomes “out”, where con is a real value function on out. In many practical applications, this function will be constant equal to 0.

Step S80: determine whether or not it is settlement time.

If it is not settlement time, proceed to Step S 90: Subtracting the matched order batch (a₁*b(1), . . . aₙ*b(n)) from the order batch (b(1), . . . b(n)) to form an unfilled order batch.

Then return to Step S40 to form a new order batch by considering the batch resulting from any new orders that may have been received added to the unfilled order batch.

Optionally, the user can specify a time limit for a submitted order such that any unfilled part or whole of that order is resubmitted into new batches for as long as the indicated time limit is not passed, but thereafter is not resubmitted.

If it is settlement time, proceed to Step S100: receive the actual out come of the event via the mechanism 20, 80, 90; multiply the coefficients aₙ by their respective function b(n) evaluated for the actual outcome of the event using settlement calculation means 58; and communicate the results to a computer terminal 100 comprising communication means 101 and transfer triggering device 102. In the case of betting, the computer terminal 100 can be, for example, a bank's computer, and the transfer triggering device 102 is for triggering transfer of financial resources, corresponding to the received results, between the exchange and the bettors. In other cases, as explained previously, the triggered transfer might be, for example, a supply of a commodity such as gas, water or electricity in response to received orders of demand or requests to supply at particular prices and times.

Construction of the target function.

The function to be optimized, ‘target’, is a real valued function on BET which represents a computational criterion, defined by the operator, for choosing the ‘best’ order batch. We prefer one of the following three methods, in decreasing order of preference:

1. Volume targets: The most natural choice for the operator (in the betting application) is to define ‘target’ as the volume of betting in the accepted batch.

There are a number of ways to define this, of the form

$$target ( b ( 1 ) , … b ( n ) ; {a}_{1} , … . {a}_{n} ) = {\sum }_{j = 1}^{n} ( size ( b ( j ) ) * {a}_{j} )$$

where ‘size’ may be defined by a ‘norm’ (in the sense of vector analysis, see Glossary) or simply an empirically defined quantity associated to bets.

Clearly this makes volume linear in the vector a in A(n), which is important to the practical implementation of this invention.

There is a wide variety of norms on BET, and here we give a number of possible definitions.

Various definitions of norm on BET:

1. Probability defined norms: If p is a probability measure on the set OUT, then the average of the absolute value of a function defines a norm on BET. Such a probability measure can be defined by the house according to its own model of the event on which BET is defined.

2. norm(ƒ)=absolute value of the maximum payout for a bet.

An example of an empirically derived at definition of ‘size’ would be the deposit or margin the punter would be required to put down for placing a given bet (which in itself will be the best measure of risk of a bet used by the house to ensure against failure to perform the bet).

2. Market value targets.

In an alternative embodiment of this invention, the house may use the (absolute) market value of the bets in the batch as a measure of the value of a batch:

$$target ( b ( 1 ) , … b ( n ) ; {a}_{1} , … . {a}_{n} ) = {\sum }_{j = 1}^{n} \vert price ( b ( j ) ) \vert * a ( j )$$

where price is the monetary value of a bet as measured from recent market activity.

In a cash or futures market, price is defined as a linear function on portfolio space. Similarly, in a betting market, price will be a linear function on betting space. Any linear function on BET (of dimension n) is determined by n numbers (see Glossary). Hence, in order to have a practical measure of price of a bet the house must estimate the n numbers that determine the price.

To assess do this, the house would use recently matched bets to estimate these n numbers, taking into account the fact that trades are simply imprecise (fuzzy) estimates of an underlying object. There is a large body of literature that describes methods for doing such statistical estimation of n parameters, and the house will use one of these standard methods.

3. Optimization of value of book according to subjective estimates of probability.

Instead of relying on the market to determine the value of a potential holding, the exchange can also form its own view of the probabilities of various outcomes, and use the expected value of the return of the house position as the target function for optimization. This leads to the formula

$$target ( b ( 1 ) , … b ( n ) ; {a}_{1} , … . {a}_{n} ) = \sum - MAP ( b ; a ) ( out ) * probability ( out ) ,$$

out ranging over all outcomes out in OUT.

Clearly this is still a linear function in the vector a in A(n) (which, as usual, depends on the order batch b).

Finally, it is possible to concatenate two or even more optimization criteria. For instance, the house can first find a set of coefficients aⱼ for which volume is maximised and, within the subset of solutions to this optimization problem, maximising Exp(−MAP(a)). In other words, the house would prefer, among matches involving £100,000 worth of bets taken, a batch of market value £100 over one of market value £10.

It is in principle possible to define target functions more general than the ones describe above, including non-linear functions, but in almost all applications it is most sensible to use a linear function on A(n), which also renders the computational effort to solve the optimization problem in real time feasible, even in very large and complex problems.

Further explanation of the optimization step.

In the above, the coefficients in A represent the choice open to the exchange, which is able to choose each of these coefficients according to its own objectives. The map MAP assigns to each point in the space A the bet resulting if the bets offered by punters were accepted by the exchange, each with the matching coefficient a. The method makes sure that the bet resulting from the choice of that point in A is subject to the hedging condition (H): i.e. that, when evaluated separately for all outcomes (which of these will occur is only to be known in the future, i.e. at settlement time), the position held by the exchange must always be greater than zero, so that the exchange never makes a loss. In alternative embodiments, a non-zero real number could be used in the inequality to represent a maximum upper bound to the theoretically possible loss, or a minimum lower bound to the revenue to the exchange, which may depend on the outcome or may be constant.

The system described above, can, of course, be embodied in a computer program, which is capable of being executed by a computer and, when executed, causing the computer to perform the corresponding method. The embodiment of the exchange 10, illustrated schematically in FIG. 2, shows separate boxes for particular apparatus; it is to be understood that these need not necessarily be different items of hardware, but some or all of them could be implemented as software modules running on a suitable computer processor. The entire exchange 10 can be a general purpose computer server running specific software to implement the invention. The above implementation also applies to the examples of embodiments described below.

How the Invention Works

The solution of the optimization problem is the vector a whose respective co-ordinates represent the coefficient or proportion by which each bet in the batch should be accepted in order to maximise the function target (M) subject to the constraints (H). Methods of solving this constrained optimization problem have already been explained above in relation to the first specific embodiment.

This optimization step in the operation of this invention is achieved by the following two fundamental steps:

considering outcomes as linear functions on the space BET (using linearisation as described in the Glossary). Thus, in the example of the previous section, as we saw, goal difference becomes a linear function on the 2-dimensional space of spread bets.

considering outcomes as linear functions on the “space of acceptance degrees”, by exploiting the linearity of the map ‘MAP’ that associates to an acceptance degree a the bet a.b (where b was the ordered bet) and composing the linear functions out with this map. A number of alternative ways in which this is done computationally is described below.

Accepting each bet bᵢ in the batch in proportion to the respective co-ordinate aᵢ of the solution vector a.

At settlement time (see Glossary), the return for the exchange is then given by the net bet held by the house evaluated on the actual outcome.

At the time at which the exchange carries out its matching, i.e. chooses the coefficients of acceptance for a submitted batch of betting orders, only the set of possible outcomes, Out, is known, and not the actual outcome that will occur at settlement time. Hence, the exchange needs to carry out its selection process on the basis of criteria known before the actual outcome is known. This is preferably done in one of the two ways according to embodiments of the present invention, as describe above: Either by using volume or by using market value. Alternatively, it can be used by concatenating the two optimization functions, first arriving at a set of possible solutions, all of which are optimal according to the first target function (say, volume) and then choosing among these the one that satisfies the second optimization criterion (say, market value).

Whilst the above description is in principle sufficient to create the apparatus and carry out the functions of the exchange, we now give further details of how the apparatuses described can carry out the processes and computations involved in running the betting exchange. We refer to the glossary for definitions of notions occurring below.

Fixing a Basis in BET

{b(1), . . . b(n))}, which defines the dual basis {b′(1), . . . b′(n)} (see Glossary):

Finding the explicit form of a matrix which, in terms of the dual basis, expresses the set of outcomes as linear forms on betting space: The j-th row of the matrix will be the j-th outcome (in some enumeration) of the event, viewed as an element of BET. If the set of outcomes is infinite, then so is the matrix of outcomes.

(1) The hedging condition

(H) −MAP(a)(out)≧con(out), (H) defines a linear constraint in a (since the functions out are linear on BET; see Glossary). Frequently con is the constant function, but in some applications, especially in the technology, as opposed to betting applications, this may not be the case.

It is sometimes convenient to write (H) explicitly in the form

(H simplified) M.a≧0, where M is a constraint matrix. This can be done by applying the duality of maps (see the Glossary), by writing

M=−MAP′(out), where MAP′ is the dual map to MAP. This yields the explicit matrix form for the constraints (H):

M(a))≧con(out)

where M=−MAP′(out),

In terms of a basis and dual basis in each of A and BET, MAP′ is the transpose of the matrix defining MAP. As we have seen MAP itself is defined with respect to a batch of orders, and hence needs to be computed in real time in accordance with the steps dealing with the processing of orders, as above.

Further Specific Embodiments of the Invention

Including Special Purpose Methods of Approximate Solutions.

Embodiments of the invention will next be described, firstly for a certain set of classes of bets, followed by some specific examples of techniques for finding approximate solutions to the optimization problem, and then some worked examples.

Whilst the functions in this paper are all bets, we use the letter ƒ for these functions, since this section deals more with formal mathematical properties than any specific properties related to the betting or other specific technological applications. We use small letters b, c, etc. for parameters defining these functions, reserving the letter a, a(1), . . . , for the acceptance coefficients.

Before describing specific classes of betting space, it is useful to point out the significance of a general property which most useful classes of betting functions according to the present invention possess:

Translational invariance of betting spaces.

In many examples of outcomes (modelled by the integers, reals, higher dimensional spaces, the circle, etc.), there is a certain set of shift operators defined. For instance, the set of integers can be shifted by a fixed integer.

It is important that betting spaces be translation invariant with respect to these shifts. The space of betting functions constructed according to preferred embodiments of this invention have this property. This allows the user to choose both a type of bet and a “centre”. For instance, the attraction of spread betting is that the user can first choose a likely result (say a goal difference), and then favour either the long or short side of that result. On the face of it, this implies that there is an infinity of functions to consider, but with the invention, all these functions can be described by two numbers, the off-set (i.e. “centre”) and the slope e.g. OS and G from the first embodiment above, or expressed as the two numbers G and C. This is possible precisely because the betting space for spread bets (2-dimensional in this case) is invariant under shifts by any number.

From the practical point of view of calculating the coefficients with which to accept a batch of received orders for bets, effectively by matching them off against each other, matching 1200 bets with 300 different off-sets is no more complicated than matching 1200 bets with only two off-sets.

1. Spread Bets.

We have already introduced an example of spread bets in section “First Embodiment . . . ”. Here we discuss spread bets in general, and analyse the general methods explained in the previous section in more detail.

1.1. Simple Outcome Spread Bets.

We assume that the set of outcomes for an event is 1-dimensional, i.e. is modelled by the real line or the set of integers, or connected intervals of such (i.e. all numbers between two given bounds). Typical examples are goal differences for football matches, best time for a sprint, the league position of a given team, the number of rounds reached by a tennis player in a tournament (integer model), or the time to first try scored in a rugby match (real line), etc.

There is an important distinction between the case where the 1-dimensional model is given by a bounded interval, and where the outcome space is best represented by an unbounded 1-dimensional model. For instance, time to first goal in a football match (without extra time) is given by the real interval [0,90], whereas goal difference is in principle unbounded, and probably best modelled by the set of integers (although for all practical purposes, all models can be taken to be bounded, due to the various relevant bounds on the speed of events).

As we have seen in the First Specific Embodiment of the invention, simple spread bets are given by affine functions from R (or Z) to the set of real numbers. Thus, BET is the space of all affine functions as in (*), below, which is isomorphic, as a vector space, to R(2), under the map (b,c) →ƒ(b,c;.).

(*) F(b,c;x)=b*x+c

With b and c uniquely defined real numbers.

1.1.1 The Infinite Case

We first deal with the case where the 1-dimensional model is unbounded, i.e. where x ranges over an infinite set of reals or integers.

The hedging condition for a function f as in (*) means that b.x+c≧0 for all x in R or Z, which implies that b=0 and c≧0.

In other words, in the 2-dimensional space of 1-dimensional spread bets, the hedging condition singles out the positive half line {(0,c), c≧0} in the plane.

Hence, in this case, the full set of hedging conditions consists of the usual constraints for the matching coefficients to lie between 0 and 1, and the two conditions for the bet resulting from applying the map ‘MAP’, in terms of the basis in BET.

(H1) −MAP(a)(1)=0 (linear term equals 0)

(H2) −MAP(a)(2)≧0 (constant term positive).

Clearly, any sensible computation of market value or expected value (see the General Description of the Invention) will define the market value of the constant function to be equal to the constant.

If a volume related target function is chosen, then this may for instance be computed by the general methods of the General description of the invention above, for instance by assigning a probability measure on the set of outcomes. This may be given, for instance, by a normal distribution centred around the most likely outcome, and with standard deviation derived from statistical results about past matches.

1.1.2 The Bounded Case

Here x ranges over a finite interval [L,U], with L and U two reals (or integers).

The hedging condition for a function ƒ as in (*)

−b.x+c≧0 for all x in [L, U].

The affine map defined by (a, c) maps the interval [L, U] into the interval [−b.L+c, −b.U+c] or [−b.U+c, −b.L+c], depending on the sign of b.

Hence, when a>0, we have

−b.L+c≧0,

otherwise,

−b.U+c≧0.

Hence, the cases a>0 and a<0 yield different inequalities. There are thus two solutions to two different optimization problems. The one that yields the better value for the target function is the one finally chosen by the system.

Again this pulls back to an optimization problem in A(n).

1.2 Multi-Dimensional Spread Bets.

Here BET=Affine functions (R(n)→R), which are parameterised as R(n+1) by (b,c)→function on R(n): x→−b.x+c.

1.2.1 The Infinite Case

As in the case of 1-dimensional spread bets, we need to distinguish between the finite and infinite range case. In the latter, as before, we see that (in the language of the Glossary

b.x+c≧0, for all x in R(n) implies

b=0, c≧0.

1.2.2 The Compact Case

Suppose that the event space is contained in some compact set S. It may in practice be impossible to solve the optimization problem precisely (there are infinitely many constraints). Hence, we may have to look for a reasonable sub-optimal solution.

We find a finite convex body (convex hull of F, a finite number of points in R(n)) which is contained in S. Then one can define a smaller region for the optimization problem by considering the finite set of linear inequalities inequalities, one for each ƒ in F,

b.ƒ+c≧0

which imply the infinitely many constraints, for each s in S,

b.s+c≧0

Hence, optimizing the target function in this restricted domain, results in a solution to the optimization problem. That solution may be sub-optimal but in many practical cases it can still be a usefull solution.

In section 5 other possible methods of approximate solution to the optimization problem are discussed.

2. Fixed Odds Bets.

2.1 Simple Fixed Odds Bets.

We list the set OUT of all possible outcomes of a given event. This could be defined, for instance, by a partition of a given larger set of physical events. For instance, we might consider the event “Winner in a horse race with 12 horses competing” (corresponding to the partition of all physical outcomes into the 12 sets, corresponding to the winning horse).

We let FIXBET=FIXBET(OUT) be the space of all functions on OUT. It is of dimension equal to the number of outcomes (which may be infinite).

Then, for each outcome out, we define the fixed odds bet on out, with odds p as any multiple of one of the n functions:

ƒ(out)=p

ƒ(out′)=−1 for all out′ different from out.

The family of basic fixed-odds functions generates FIXBET as a vector space.

By the methods of the previous section, we are able to deal with fixed odds bets. The hedging condition is defined by the condition that, for the house position h (i.e. −MAP(a), in the language of the previous section).

h(out)≧0 for all out

The optimization function can then be defined by one of the linear methods in the previous section.

For any simple fixed odds betting space on an event set consisting of n outcomes, and for any set of m betting orders on any of these events, the map MAP takes the form of an n by m matrix whose columns are equal to −c, where c is the stake, for the rows corresponding to all events other than the one being bet upon, and equal to +p.c where p is ‘the odds’, i.e. winnings as a proportion of stake, for the row corresponding to that event.

For Instance,

if the 1^{st} order is a £1,000 betting order at 3:1 odds on result labelled 2, in a 5-outcome event set, then the first column of MAP(a) would have the form:

−1,000

3,000

−1,000

−1,000

2.2 Complex Fixed Odds Bets.

In 2.1 we assumed that we are dealing with a set of n mutually exclusive outcomes (simple fixed odds bets), with n a manageable number. There are natural situations in which this is not the case, and here we give one example.

We envisage a league with n players or teams, with outcome given by some ranking among the teams. Hence each outcome corresponds to a permutation of teams. For instance, in a 3-team league in which teams were labelled t1,t2,t3, an outcome might be: team t2 comes first, followed by t1 and t3 in that order. For any reasonable number of participants, the number of these permutations (Factorial(n)) is a very large number, and hence on the face of it the collection of such results lead to difficult matching problems, which need careful care in constructing manageable specific implementation.

Clearly, there are large numbers of interesting bets that can, and indeed are, commonly taken on league positions. For instance, it is natural to bet that a given team does or does not come among the top 2, top 5 or top k teams, k any number smaller than the number of teams competing. Clearly the collection of bets, for each k and for arbitrary constant c,

“Team t comes among the top k places, at odds c: 1”,

is not a disjoint collection of bets, and hence the methods of 2.1. do not apply to the problem of the efficient and riskless matching of the entire collection of such bets. This is a very large collection of bets, and at first sight it may appear that a suitable betting space to accommodate all of them may be too large for practical implementation. However, this is not the case. We exhibit here a betting space, which we denote by RANKBET, to which the methods of this invention apply, and which is broad enough to accommodate all fixed odds bets on these mutually overlapping events. We now describe how to construct this space.

First, it is convenient to label a result for an n-team league (i.e. the corresponding permutation of teams given by the ranking at the end of the tournament, season, etc.) as an n by n matrix as follows:

out(kj)=1 if team j comes in k-th place and 0 otherwise.

For instance, the outcome for the 3-league team as above Would be coded as the 3 by 3 matrix.

$$out = ( \begin{matrix}0 & 1 & 0 \\ 1 & 0 & 0 \\ 0 & 0 & 1\end{matrix} )$$

We define the space RANKBET to be the vector space of all n by n matrices (n the number of teams). As a vector space, RANKBET is the (unique) n² dimensional real vector space. It can thus be viewed as the space of linear functions from itself to the real line. If M is an n by n matrix, then such a linear function is defined by the formula:

$$M \cdot out = {\sum }_{j , k = 1}^{n} ( M ( j , k ) * out ( j , k ) )$$

Hence, in particular any n by n matrix M defines a function on out, the set of outcomes (in their coding as n by n matrices explained above).

For example, for the example matrix out, the matrix

$$M = ( \begin{matrix}- 3 & 2 & 1 \\ 5 & 0 & 7 \\ - 1 & 0 & 4\end{matrix} )$$

when applied to out, would yield

M.out=2+5+4=11.

We now show how to represent any bet of the type described above (bet at p:1 odds that team t comes at least in the top k places) as an element of RANKBET: This bet is represented by the matrix all of whose columns other than the column representing t are 0, and column t has −1's in all rows lower than k, and c in all rows higher than or equal to k. For instance, the fixed odds bets on team j coming in k-th place, at p: 1 odds, are of this form. For instance, the 4:1 bet on team 1 coming in 4^{th} place in a 4-team league would be given by the 4 by 4 matrix

$$( \begin{matrix}- 1 & 0 & 0 & 0 \\ - 1 & 0 & 0 & 0 \\ - 1 & 0 & 0 & 0 \\ 4 & 0 & 0 & 0\end{matrix} )$$

Similarly the 12:1 bet on team 1 coming in at most 2^{nd} place in a 4-team league would be given by the 4 by 4 matrix

$$( \begin{matrix}- 1 & 0 & 0 & 0 \\ 12 & 0 & 0 & 0 \\ 12 & 0 & 0 & 0 \\ 12 & 0 & 0 & 0\end{matrix} )$$

Thus, we have created a relatively low-dimensional betting space in which we can embed a very important and large class of interesting fixed odds bets on any set of events that involve ranking. In the case describe above, the rankings were total rankings (i.e. every team winds up with a unique rank) but similar constructions apply to the situation of partial rankings (such as the stage in a tournament at which a given player is knocked out). For instance, for a 20-team league, the dimension of RANKBET is 400, whilst the dimension of the space of all possible functions on OUT is astronomically large (Factorial(20)).

Despite the reduction in computational complexity due to the relatively small dimension of RANKBET, the optimization problem is still difficult, to the large number of hedging conditions, and we must find effective methods for solving this problem.

In numerous cases, including the examples given, it is possible to reduce the complexity of the optimization problem without sacrificing the quality of the solution by considering the following equivalence among outcomes (permutations). In principle, we need to solve our optimization problem subject to one constraint per permutation. We notice, however, that two distinct permutations may be the same as far as specific set of bets is concerned, and hence do not need to be considered separately. For instance, in the example considered above, of the 12:1 bet on team 1 coming in at most 2^{nd} place in a 4-team league, there are only two effectively distinct classes of outcomes as far as that particular bet is concerned: Those for which team 1 comes first and the rest. Hence, there are not 24 outcomes, but only 2 outcomes. We can consider all outcomes as being equivalent to one of two specific outcomes.

$$( \begin{matrix}- 1 & 0 & 0 & 0 \\ 12 & 0 & 0 & 0 \\ 12 & 0 & 0 & 0 \\ 12 & 0 & 0 & 0\end{matrix} )$$

More generally, for any specific set of bets we can introduce a notion of equivalence according to whether or not two outcomes give the same payout for all bets in a given batch of bets. We can write out1˜out2 if they give the same result for a given batch. Obviously this depends on the batch of orders, but the current invention works as a real time optimization system in which the optimization problem is solved in real time as a function of the batch being considered.

Given the impossibility of solving in real time the full hedging problem (factorial(n) constraints in the number of variables equal to the number of orders), we shall indicate a number of approximate methods which, whilst not guaranteed to find the true optimal solution, will still generally result in a reasonable solution. This will be done in subsection 5 of this section. We shall do so by forcing the house position into a smaller set than that defined by all inequalities above, which is easier to compute.

3. Exotic Bets

Many examples of exotic bets are given in the Glossary. The present invention can be used with such bets instead of spread bets and fixed-odds bets as described above, or indeed can be used in combination with them as explained below in section 4.

4. Combining Different Classes of Bets.

Given a set of outcomes, there are distinct classes of bets (functions), such as spread bets, fixed odds bets, etc., defined on the same outcome space. As we have seen, the matching problem for the house reduces to a problem of linear optimization on the spaces A(n) constructed in Section 1.

As we have remarked, it is useful to be able to combine bets in different classes, for instance fixed odds and spread betting, within the matching algorithm.

To do this, one simply needs to construct the sum (not necessarily direct) of the corresponding function spaces, which is a standard construction in linear algebra. For instance, FIXBET and SPREADBET intersect in the space of constant functions on outcomes.

5. Special Approximate Methods

In many cases of practical interest, the problem of solving the constrained optimization problem is not feasible in real time (depending on available computing resources). In order to deal with such cases, a number of special techniques are presented, which will yield an approximation to the optimized solution, while at the same time satisfying the constraints rigorously (no market risk for the house).

5.1 Spread Bets on Rank of a Team

The example of league positions for a set of teams is given in the Glossary. As we have seen, for reasonably large n, Factorial(n) is too large a number to be able to solve these inequalities. Here we define methods for reducing this number.

Method 1: Decompose into 1-dimensional matching (team by team), thus reducing the problem to the very easy problems dealt with in section 1.1. This is a “method of last resort” only, and is too far from optimality to be of any great interest. It simply represents an insurance policy against the danger of the betting system simply being unable to cope.

The second method presented here, by contrast, often yields results quite close to the optimal solution, and yet reduces the complexity of the matching problem from Order(Factorial(n)) to Order(n).

Method 2: Imposing an a Priori Rank.

For all Fact(n) permutations p, the hedging condition for h, the house position, is that the net payout for the house position is non-negative. Given the form of betting space for multi-dimensional spread bets, as described above, this means that for all permutations p, coded as vectors giving the rank of the first, second, . . . , player or team, and using the notation of the glossary,

(*) h.p+c≧0, for all permutations p.

We can now consider the smaller set of solutions to this set of inequalities, by adding

(**) h(j₁)≦h(j₂)≦h(j₃)≦ . . . h(jₙ),

where (j₁,j₂ . . . ) is a particular permutation defined by the house.

Clearly any set of solutions to the combined set of inequalities (*) and (**) is in particular a solution for (*). However, it is equally clear that, for any h that satisfies (**) it is possible to replace the full set of permutations by one single permutation, namely by

p=(j₁,j₂ . . . ).

For instance, consider the case n=3. For any house position h=(h(1), h(2), h(3)) for which h(1)<h(2)<h(3), clearly the largest value of h.p among the 6 permutations of 3 teams, is given by the outcome: team 3 comes last, 2 second and 1 top.

Hence, by accepting the additional 2 constraints h(1)<h(2)<h(3) for the position it is willing to hold, the house can reduce the total number of constraints from Factorial(3) to 2 (the portfolio constraints)+1 (the single inequality h.p+c≧0 for the least favourable outcome.

On the face of it, the additional constraint (**) is very restrictive. However, in practice this may not be the case. For instance, in the context of a house accepting orders for bets, it may be that customer flow is very oriented, towards the most favoured team. Everyone usually bets on the current “best player” to win the Masters, or the US Open, etc.. Hence, by forcing its own holdings to reflect the natural inclination of the market, it may not constrain the actual optimal solution to the matching problem too severely in practice.

It is also open to the systems operator to run the system heuristically, by trying out different permutations for forming the optimization problem with respect to (**), then compute the maximum with respect to each of these, and then choose the globally best solution.

Often it is desirable to use the ordering induced by the portfolio of raw orders in the batch, which reflects market demand for bets in different teams.

Method 2′: Here, we suppose the house believes that there are only a small number s of serious favourites.

It is possible then to introduce inequalities that define those portfolios that satisfy the condition that holdings in those s teams must be greater than for any of the other teams. Then, one needs to consider the n inequalities implying that plus the Factorial(s) inequalities corresponding to each of the permutations of the s favoured teams.

Method 3: Iterate method 2 as follows: choose a permutation p. By method 2, obtain a first match a. Subtracting the matched part of the order batch from the original order batch yields the unmatched part. Now consider the permutation p′ induced by the ordering of the unmatched part.

Reapply method 2 to this unmatched order, find a new match among the previously unmatched orders.

Inductively, this defines an iterative procedure which finds better and better matches.

Method 3′: This method can be applied dynamically, adding new orders to the existing unmatched order flow.

Method 4: This method can be applied in conjunction with the methods above. It consists in ranking orders, for instance with reference to a given market price, and selecting, for each team, the most competitive order in that team, both on the buy and sell side. Then submit only this most competitive batch for matching, and deal with it by any of the above methods. This reduces the complexity of the matching problem by reducing the number of orders, and hence the dimension of the space in which the optimization takes place.

Having performed the match on the most competitive batch, iterate by using only unmatched orders remaining in the system.

Again, this method can be applied dynamically to a real time order flow.

Method 5: Parallelisation

Divide the order batch into sub-batches, for example orders for bets on one particular team or small group of teams would be placed in one sub-batch. Assign different processors, each comprising, for example, elements illustrated within the exchange 10 in FIG. 2, to each of these and apply any of the above methods.

5.2 Approximate Methods for Complex Fixed-Odds Bets

We consider the problem studied in section 2.2, i.e. fixed odds bets involving specific rank of a specific team (or upper or lower bounds therefore). For values of n bigger than 6 (or so), one needs to make simplifications. These simplifications may give rise to seriously suboptimal solutions, and hence it is an important research problem to make these simplifications as efficient as possible.

The inequality in RANKBET takes the form:

(*) H.P≧0, for all permutation matrices P where H is the house position, which can be re-written in coordinates as:

$$H \cdot P = {\sum }_{j , k = 1}^{n} ( {H ( j , k )}^{*} P ( j , k ) )$$

We shall write p for the permutation represented by the matrix P (as explained previously).

Since P is a permutation matrix, i.e. has only one non-zero entry in each row, this can be rewritten as:

$$(* *) H \cdot P = {\sum }_{j = 1}^{n} ( H ( j , p ( j ) ) \geq 0$$

To solve this problem, one needs to find the maximum over all permutations of the expression (*), but this is often an unfeasibly large set for performing the optimization.

(for symmetric matrices this is equivalent to the famously difficult travelling salesman's problem).

Practical solution 1:

$$(* **) {\sum }_{j = 1}^{n} ( H ( j , {p}^{′} ( j ) ) \geq 0$$

where p′ is the function on the index set {1, . . . , n} defined by:

H(j,k)=min{H(j,l),l=1, . . . n}

Clearly, for all p:

$${\sum }_{j = 1}^{n} ( H ( j , p ( j ) ) \geq {\sum }_{j = 1}^{n} ( H ( j , {p}^{′} ( j ) )$$

and hence any solution to (***), for the specific map p′ is automatically a solution to the hedging conditions (*) for all p, in other words is a feasible solution to the optimization problem.

Hence, one can replace the Factorial(n) inequalities (**) by the one inequality (***) and obtain a feasible solution. Clearly this may result in a sub-optimal solution. As above, it is useful to iterate this solution, by subtracting matched solutions from order batches, in dynamic fashion.

Practical solution 2:

As before, in the case of spread bets, it is possible to replace the full set of inequalities by one inequality plus n−1 0inequalities that prescribe the ordering of the team components of the house position.

### 6. WORKED EXAMPLES

### Example 1

Spread Bets on 3 Teams in a League.

The set of possible outcomes consists in the 6 possible final rankings, i.e. all permutations of three objects. It is convenient to represent these as the 6 vectors obtained by permutation from the vector (1,2,3) in R(3). Basic (unit amount) spread bets are then given by the set of affine functions with multiplier equal to +1 (long bet) or −1 (short bet), and off-set equal to any number (integer or fraction) between 1 and 3.

In the language of section 1, a typical element would be written as (0,1,0;−2) which would mean the spread bet on team 2 coming in at least at rank 2.

As we have seen, arbitrary affine functions can arise for the house which will accept linear combinations of bets. Equally, clients themselves might submit spread bets of a more general kind, combining the ranks of different teams. For instance, (1,−1,0;0) would correspond to a spread bet on the difference of ranks between teams 1 and 2.

As we have seen, the resulting space, BET, is the space of affine functions on R(3), which, as a vector space, is isomorphic to R(4).

In this example, we can present the precise form of the linear optimization problem.

First, we give the optimization problem on BET, in terms of the coordinates for a typical element in BET:

bet=(l₁, l₂, l₃, s),

which defines bet as the function on R(3) (outcomes).

(In the language of the Further Embodiments of the Invention, the vector (l₁, l₂, l₃) corresponds to the vector component b, the s to the constant component c of the general representation of an affine function as a pair (b,c), where b is a vector and c a number.)

For the outcome (1, 2, 3), for instance, we find:

bet((1,2,3))=l₁+2×l₂+3×l₃+s

The 6 outcomes now become linear functionals on BET. We need to describe this as a 6 by 4 matrix. Here is the explicit matrix M which codes for the set of 6 linear functionals on BET:

$$M = ( \begin{matrix}1 & 2 & 3 & 1 \\ 2 & 1 & 3 & 1 \\ 1 & 3 & 2 & 1 \\ 2 & 3 & 1 & 1 \\ 3 & 1 & 2 & 1 \\ 3 & 2 & 1 & 1\end{matrix} )$$

The first 3 columns code for the actual rank for each team (for the 6 possible outcomes, which correspond to the 6 rows), which multiplies the respective holdings in that team that define the spread bet.

Thus, suppose the bet held by the house was

h=(2, 2, −2, −5)

Then, to check inequality (H) in betting space, one would look for:

M*bet≧0 (H)

one would calculate

$${M}^{*} bet = \begin{matrix}- 5 \\ - 5 \\ - 1 \\ 3 \\ - 1 \\ 3\end{matrix}$$

Hence (H) is violated, and the house would be exposed to loss for events 1, 2, 3 and 5. The house would never have accepted a combination of bets resulting in the netted house position above. It is precisely in order to avoid such risk that the hedging condition is essential to the functioning of this invention.

We now explain how to construct the optimization apparatus in terms of the constraint (H) applied to the matching coefficients a in this example.

We assume that the following orders for spread bets are being submitted.

Order 1: Bet 5 pounds on team 1 coming in higher than 2.5

Order 2: Bet 10 pounds on team 2 coming in higher than 2.1

Order 3: Bet 15 pounds on team 2 coming in lower than 1.5

Order 4: Bet 150 pounds on team 3 coming in lower than 2

Order 5: Bet 200 pounds on team 3 coming in lower than 1.5.

In this case, in the language used in the general explanation of the invention, n (number of orders) is 5, and hence we obtain a map MAP from A(5) (the box in R(5) with coordinates between 0 and 1) to BET (the 4-dimensional betting space above). In matrix terms (a 4 by 5 matrix), this map takes the form (defined by the orders 1 through 5 above) as follows:

$$MAP = ( \begin{matrix}5 & 0 & 0 & 0 & 0 \\ 0 & 10 & - 15 & 0 & 0 \\ 0 & 0 & 0 & - 150 & - 200 \\ - 12.5 & - 21 & 22.5 & 300 & 300\end{matrix} )$$

For instance, the last column denotes the bettor's desired 200 pound short holding in team 3, with off-set term in the corresponding affine function equal to 300 (1.5 being the off-set rank).

In order to define the optimization problem central to this paper, in this simple case, we find the matrix H=M.MAP (which is a 6 by 5 matrix, and hence represents a map from R(5), representing the trade acceptance coefficients, one for each order, to R(6), representing the 6 outcomes, viewed as linear functionals on BET and hence, by the pull-back on R(5).

The full optimization problem then, in this simple case, is represented by an apparatus that can compute

H.c≧0 (vector inequality, 6 inequalities)

0≦c≦1 (coefficient constraint, indicating that an order can only be filled to an extent between not at all and completely, 10 inequalities).

Maximise the value of max(−MAP(a)), i.e. the market value of the house's position resulting from taking the other side of each of the 5 trades, modulated by the coefficients aⱼ, computed by applying the optimization function chosen by the operator.

### Example 2

Mixed Fixed Odds and Spread Bets

Here we assume a bet on who wins the league, and spread bets on rank, for a 3 team league.

We have observed that the 2 betting spaces are each 4-dimensional (dimension of the space in which outcomes are embedded, i.e. 3 plus the constant term), and that they intersect in the space of constant functions. Hence, BET, the combined betting space, is 7-dimensional.

Hence, we now have a 6 by 7 matrix M which codes for the linear functionals for which the matrix inequality M.b≧0 represents the constraints in the optimization routine.

BET has natural basis indexed by 3 spread bet positions {sp(1), sp(2), sp(3)}, 3 fixed bet positions {fp(1), fp(2), fp(3)} and a constant (which designates the cash component of the bet).

Hence the inequalities are given by a matrix inequality (MAP.bet is the payoff to the house given the various possible outcomes)

MAP. bet≧0, where MAP is a 6 by 7 matrix, as follows

$$MAP = ( \begin{matrix}1 & 2 & 3 & 1 & 0 & 0 & 1 \\ 2 & 1 & 3 & 1 & 0 & 0 & 1 \\ 1 & 3 & 2 & 0 & 1 & 0 & 1 \\ 2 & 3 & 1 & 0 & 1 & 0 & 1 \\ 3 & 1 & 2 & 0 & 0 & 1 & 1 \\ 3 & 2 & 1 & 0 & 0 & 1 & 1\end{matrix} )$$

The meaning of row 1 of MAP, for instance, is that (1 2 3) will multiply the spread bet components of bet, (1 0 0) multiplies the fixed odds components held (if team 1 comes top then any fixed odds position in team 1 winning will win, whereas those in teams 2 and 3, which come in second and third, will lose, i.e. the corresponding vector components will be counted with coefficient 0).

Observation. This example can be used to show that cross category matching can match batches of bets which could not be matched when the two order flows in fixed odds and spread bets are decoupled. To give a 3 by 3 example for a cross type matching situation, in which neither spread nor fixed odds bet is matchable, but the combination is, we just need to apply MAP to two elements of BET, fix in FIXBET, spread in SPREADBET (both 4-dimensional and intersecting in the constant line), such that MAP.fix is not positive, MAP.spread is not positive, but MAP(fix+spread)>0.

### Example 3

1-Dimensional Spread Betting, Unbounded Case, 100 Orders

Maximise expected return subject to: For all x,

b.x+c≧0hence

b=0, c≧0 and maximise c.

Via the map ‘MAP’, and the parametrisation of spread betting space (ƒ(b,c.), b and c are linear functions from A(100) to R, and hence

| | |
|---|---|
| b(a) = 0 | (1 inequality) |
| c(a) ≧ 0 | (1 inequality) |
| 0 ≦ aⱼ ≦ 1 | (200 inequalities) |

are the inequalities defining the hedging condition.

The target function will in this case usually be defined by c as a function of a. As observed, MAP itself, and hence the inequalities and target function, are determined in real time from the order flow.

### Example 4

Simple Fixed-Odds Betting, Exhaustive Set of 3 Events, 100 Orders.

As explained in section 2.1, betting space consists of all functions on a 3-element set (i.e. is R(3)), and hence we have the 3 linear inequalities expressing the condition that the function −MAP(a)(out)≧0, for all out1, out2, out3, in addition the 200 inequalities defining A(100).

### Example 5

Multi-Dimensional Spread Bets

Say, spread bets on end of season ranks of Premiership (a league with 20 teams), with 100 orders. Betting space is the 21-dimensional space of affine functions from R(20) to R. Hence, the general form of the inequality in betting space b.x+c≧0, c in R, a in R(20), for all permutations of 20 teams, and the condition that rank is bounded, implies that the special approximate methods of the Further Embodiments, described above, apply directly.

For instance, applying method 2 of section 5.1, to a particular ordering p (expected by the market, and observed from the order flow), we obtain the 19 inequalities for the house position h

h(p(1))<h(p(2)) . . . <h(p(20)) and

h.p+c≧0

Hence, the optimization problem leads to an optimization problem with 220 inequalities in 100 unknowns, i.e. 220=200 (0≦aⱼ≦1)+19 (order of house position)+1 (h.p+c≧0).

It would also be possible to apply the more comprehensive solution (Method 2′ of section 5.1), if, for instance, the house took the view that there were only 5 serious favourites on which betting would concentrate.

It therefore sets things up so that accepted betting volume can be in any order on those 5 (120 outcomes), and that betting on any of these must be greater than 6-th>7-th, etc.

Then we have to solve the inequalities

b.x+c≧0 for all 120 orderings (i.e. permutations of {1, . . . 20}) such that

b(j)>b(6),j=1 . . . 5 (5 inequalities),

b(6)>b(7)> . . . b(20) (13 inequalities).

The 120 outcomes resulting from allowing all permutations of the five favoured teams (leaving the irrelevant teams 6, . . . 20 in their original order) together with the inequalities on the house position will then imply all factorial(20) inequalities, as observed above in the section on Further Embodiments.

Hence, we have 333 inequalities (120+13+200 inequalities) in 100 unknowns to solve.

This corresponds simply to having found a simpler domain contained in the original domain for which the problem had to be solved.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any subcombination.

Embodiments of the invention may be implemented in hardware and/or software modules.

Whilst specific embodiments of the invention have been described above, it will be appreciated that the invention may be practised otherwise than as described.

It is pointed out that B. Seifert and K. Croxson are co-inventors of the aspect of the invention according to claims 27 to 30 and 57 to 60, and that B. Seifert is the sole inventor of all the remaining aspects of the invention.

Glossary

Outcomes:

For a particular event, such as a sporting match, a set of outcomes can be precisely mathematically defined. The following are a few illustrative examples.

The set of outcomes, lose-draw-win, for a competitive event could be described by the 3-element set {−1, 0, +1}.

The set of possible outcomes of the position of a specific team in a league can be defined by the set of integers from 1 to n, i.e. {1, . . . , n}, where n represents the number of teams in the league. For the positions of all n teams there are factorial(n) possible outcomes.

The set of outcomes of the goal difference of a soccer match is described by the set of integers (an infinite set).

The set of outcomes of the result of a soccer match in terms of the number of goals scored by each team is described by the product of the set of non-negative integers (an infinite set).

The outcome of a tennis match: for a 3-set tennis match, describing the outcome in terms of number of games won by each player in each set (neglecting tie-breaks for the purpose of the illustration) the rules of tennis dictate that the outcome must be an integral point in one of the sets {0, 1, . . . , 6}^{j}, with j an integer equal to either 4 or 6 (corresponding to either two or three sets being played), with each co-ordinate an integer between 0 and 6 inclusive, such that of two adjacent co-ordinates [x(j), x(j+1)], with j odd, precisely one is equal to 6, and such that the co-ordinate 6 may occur at most three times, and only twice with co-ordinates of equal parity. Furthermore, the outcome is described by a 4-tuple precisely when either: (i) both the first and third; or (ii) both the second and fourth, co-ordinates are equal to 6; and is described by a 6-tuple in all other cases. We shall denote the set of outcomes by Out and specific outcomes by out or out1, etc.

Event:

The same physical event (such as a particular soccer match) can give rise to a number of different “events” as defined herein, such as goal difference, number of goals scored by each team and so on. An event is simply a way of recording or modelling the set of outcomes of some observable sequence of actions. The outcome of each event is the relevant element or point in the set describing that event. The event will occur at some time in the future relative to the time at which bets are made between participants and the exchange.

Settlement. The process of evaluating the betting functions (of the exchange and the players) on the actual outcome that has occurred at the time the event is known. This corresponds to recording the financial gain or loss of the bet coded for by the betting function.

Settlement time. This is the time at which settlement occurs.

Actual outcome. This is the outcome, among the set of outcomes, which actually does occur, and which is only known at settlement time.

Linearisation. The mathematical device, for a vector space V of functions ƒ on a set S, of considering each element s as the function l(s) on V through the formula

l(s)(ν)=ν(s).

It is a key observation of pure and applied mathematics that l(s) is a linear function on V.

Bet:

An agreement between two parties A and B to transfer bet(out) amount of money from A to B, where bet is a function from the set of outcomes “out” of an event to the real numbers (representing money or particular “currency units”). If bet(out) is negative this means B has to pay −bet(out) to A, otherwise A pays bet(out) to B. This defines the bet bet between A and B. The function bet should have defined values for the whole set of outcomes describing the event, and these should include both positive and negative values (otherwise the “bet” would amount to charity from one party to the other, the same party always paying out regardless of the outcome).

Betting order. A betting order is an instruction supplied by a client to the exchange for a bet that the client wishes to take with the exchange.

Order batch. An order batch is a collection of betting orders considered simultaneously by the exchange.

Match. A match is a collection of coefficients ranging between 0 and 1 indicating the degree to which a betting order is being accepted, i.e. of fractions with which the orders are multiplied and then accepted as bets by the exchange.

Optimal match. An optimal match is a match optimal with respect to an optimization criterion, subject to the exchange being completely hedged (i.e. having a net positive pay-out with respect to the collection of all clients submitting orders within a given batch being matched).

Dual space and dual basis. Given a vector space V, the dual space V is defined to be the linear space of linear functions from V to the real line. Given a basis {b(1), . . . b(n))} in V, the dual basis of V′ is defined to be the basis {b′(1), . . . b′(n)} defined by the n² equations:

<b′(j),b(k)≧1 iffj=k and 0 otherwise.

Linear pairing between V and V′. Given vectors ν in V and ν′ in V′, ν.ν′ shall denote the result of applying ν′ to ν. If ν=(ν(1), . . . ν(n)), and ν′=(ν′(1) . . . ν′(n)) (in terms of a basis and its dual basis) then

$$v \cdot {v}^{′} = {\sum }_{j = 1}^{n} ( v ( j ) \cdot {v}^{′} ( j ) )$$

Duality of linear maps. When m: V→W is a linear map, the there is a natural ‘dual map’ m′: W→V′, defined by

m′(l)(ν)=l(m(ν)).

Norm: For any vector space V, a norm is a function from V to the real line which satisfies the condition that the value of the function of a positive real multiple of any vector is the multiple of the value of that function, the value of the function of a negative real multiple of any vector is minus the multiple of the value of that function, and that the value of the function on a sum of vectors is never more than the sum of the values of the function for each function separately. The standard example of such functions on the standard plane is the sum of squares of coordinates in that plane.

Dot product. For any two vectors ν and w in a given vector space, with a fixed basis, ν.w denotes the dot product, defined as the sum of the products of their respective coordinates.

Classes of Bet:

The betting spaces corresponding to the bets below were introduced above in the section on Further Specific Embodiments of the Invention.

Fixed-Odds Bet:

Simple fixed-odds bet: for a set of mutually exclusive outcomes, a fixed-odds bet is classified as “simple”, and a basic bet of this class between parties A and B takes the form ƒ(x)=+odds if the outcome x lies in P, and −1 if it lies in the compliment of P, where “odds” is positive and represents the pay-out to B by A, and P represents some partition of the set of outcomes. Clearly multiples of this basic bet are still fixed-odds bets, and the multiple (in terms of currency units) is also referred to as the “stake”. A typical example of such a bet would be for a league of teams, where the partition P is defined as all outcomes of the league in which the rank of team j is 1; in common parlance this would be referred to as betting on a particular team (j) coming first in the league. Only one team can come first, so the outcome of team j coming first is mutually exclusive with the outcome of any other team coming first.

Complex fixed-odds bet: cases where the set of outcomes is not mutually exclusive, for example for a league of teams, a bet of the form ƒ(x)=+odds if the outcome x is such that a particular team comes in the top 5 positions in the league, ƒ(x)=−1 otherwise, and a bet that a different team also comes in the top 5 positions in the league, are not mutually exclusive.

Spread Bet:

Bets of the form ƒ(x)=−g*x+c, where the outcome x has a numerical value, such as the goal difference of a soccer match, the league position of a team, the number of rounds reached by a tennis player in a tournament, or the time to first goal scored in a match, and g and c are uniquely defined real numbers for each particular bet. In terms of the first example given in the description above at equation (1), in this general formula for a spread bet, ƒ(x) corresponds to the bet b, x corresponds to the goal difference outcome D, −g corresponds to the stake G, and c corresponds to −G*OS (minus the product of the stake G and the off-set OS).

Spread bets, as conventionally defined by the above formula, are linear functions on the outcome x, i.e. depend on the product of x and a scalar g. However, a more general betting function could be written in the form ƒ(x)=−g(x)+c, with g some function of x. By restricting g to lie in some set of functions other than linear ones, some interesting bets could be obtained, which are not excluded from the present invention, but which are not conventionally classed as spread bets.

Parity Bet:

A bet defined by a function on the set of integers (such as number of goals scored in a match) of the form ƒ(m)=−1 if m is odd, and c if m is even (where c>0) (or vice versa swapping odd and even), e.g. a bet that the total number of goals scored in a match will be even.

Continuous-Odds Bet:

These bets are defined for sets of outcomes embedded in a suitable n-dimensional space. They are characterized by a “modulation function”, fmod(r), which attains a unique maximum value finax at the origin r=0 (r being the position vector in the space) and falls off rapidly to −1 away from the origin. Actual basic bets are translations of such a function to an arbitrary point in the outcome space i.e. ƒ(x)=fmod(x−p), where x is the actual outcome and p is effectively the outcome predicted by the bettor. The bettor wins if the actual outcome x is close to the outcome p bet on by the bettor, with maximal winnings for x=p. Actual bets will, of course be scaled versions of the basic bet, with the scaling factor equal to the bettor's stake. If the actual outcome is far removed (in some sense defined in the outcome space) from the bettor's predicted outcome, the bettor will lose his stake entirely.

An example of a betting function ƒ(x) of this class, for a one-dimensional outcome space x, is illustrated in FIG. 5. Interesting families of modulation functions are given by exponential functions, for example Gaussians.

It can be seen that fixed-odds bets are really a specific example of continuous-odds bets in which the modulation function is infinitely steep (delta-function-like), and has a maximum value equal to the odds at a specific point, and −1 elsewhere.

Inverse Continuous-Odds Bet:

A bet whose pay-out increases as the outcome becomes more removed from a given point in the outcome space (for example the pay-out increases as the outcome differs in absolute value from a given value). This class of bets is effectively betting that the outcome won't be a given value nor close to that value.

Oscillator Bet:

A bet (as a function of the integers, such as number of goals scored etc.) whose absolute value increases with the absolute value of the outcome (integer), but whose sign oscillates like a parity bet. For example ƒ(x)=(−1)^{x}|x|. This class of bet can be written as the product of a parity bet and an inverse continuous odds bet.

Alternating Spread Bet:

These are bets of the form ƒ(x)=s(x)*p(x), where s is a spread bet and p is a parity bet on a 1-dimensional set of outcomes.

Cumulator Bet:

A cumulator bet, also known as a “parlay”, is a bet defined in terms of a sequence of two or more bets, in which the winnings of the first bet are invested as the betting stake for the second bet (and so on for subsequent bets, if any). If the bettor wins all the bets, the pay-out is the product of all the individual pay-out functions, which can be very large. If any bet is lost, the bettor simply loses the basic stake on the first bet. The plurality of bets can be on completely unrelated events and may be a mixture of different classes of bet such as those described above. Mathematically, a cumulator bet function lies in the tensor product of the function spaces in which each individual bet lies.

Exotic Bets:

Bets other than fixed-odds bets and spread bets are sometimes termed “exotic bets”. This term also includes combinations of bets of more general kind than cumulators.

1. An optimization method comprising the steps of:
specifying an event;
defining a set of outcomes for said event;
defining at least one function representing a transaction between an exchange and another party, said at least one function being dependent on the outcome of said event;
receiving, at said exchange, orders for at least one said transaction from at least one other party;
applying a map between the space generated by the or each at least one function and the space defined by coefficients representing the proportion to which each received order is to be accepted; and
calculating a solution for the values of said coefficients, using said map, subject to a defined constraint and an optimization criterion.

2. A method according to claim 1, wherein said calculating step further comprises constructing a target function, with respect to which said coefficient values are optimized, said target function being constructed in real time based on the current orders being processed.

3. A method according to claim 1 or 2, wherein said optimization criterion comprises obtaining the maximum expected revenue for the exchange.

4. A method according to claim 3, wherein said expected revenue is defined as the market value of the orders held by the exchange.

5. A method according to claim 3, wherein said expected revenue is defined in terms of a probability measure on said set of outcomes.

6. A method according to any one of the preceding claims, wherein said at least one optimization criterion comprises maximizing the volume of accepted orders.

7. A method according to any one of said preceding claims, wherein said constraint comprises a hedging condition representing the maximum risk to which the exchange is to be exposed.

8. A method according to claim 7, wherein said hedging condition is that the maximum potential loss by the exchange is less than a predetermined amount, and preferably less than zero.

9. A method according to any one of the preceding claims, comprising the step of representing said map in terms of a matrix.

10. A method according to any one of the preceding claims, further comprising the step of determining which of the possible outcomes of the event has occurred.

11. A method according to claim 10, wherein said outcome is determined by receiving data from an online web site.

12. A method according to any one of the preceding claims, wherein said orders are received at said exchange via the Internet or other telecommunications network, and are formed into one or more order batches for storage and processing.

13. A method according to any one of the preceding claims, wherein a said at least one defined function comprises a spread bet function.

14. A method according to claim 13, wherein said step of calculating a solution comprises decomposing the functions represented by the received orders into 1-dimensional groups each representing bets on one particular participant in said event.

15. A method according to claim 13, wherein said step of calculating a solution comprises imposing a rank on received orders which reflects the market demand for bets on different participants.

16. A method according to claim 13 or 15, wherein said step of calculating a solution comprises applying a condition that the holdings by the exchange in orders for a specified sub-set of participants must be greater than for any of the other participants.

17. A method according to claim 15 or 16, comprising:
calculating a solution for the value of the coefficients for acceptance of the received orders;
removing the orders with non-zero coefficients; and
repeating the step of calculating a solution for the coefficients of the remaining orders.

18. A method according to claim 17, comprising iterating the method of claim 17 at least once.

19. A method according to claim 17 or 18, comprising, prior to repeating the step of calculating a solution, adding new orders to be processed along with the previously unaccepted orders.

20. A method according to any one of claims 13 to 19, comprising:
selecting from the received orders, the most competitive order for a bet on each participant, both on the buy and sell side;
submitting only the selected orders to said step of calculating a solution;
removing orders with non-zero coefficients;
repeating the selecting, submitting and removing steps iteratively.

21. A method according to claim 20, further comprising adding new orders prior to said selecting step.

22. A method according to any one of claims 13 to 21, comprising:
dividing the received orders into sub-batches;
processing the sub-batches in parallel, each according to the method of any one of claims 13 to 21, to obtain solutions for the values of the coefficients of acceptance for each order in each sub-batch.

23. A method according to claim 22, wherein the sub-batches are defined in terms of orders for bets on one or more participants in said event.

24. A method according to claim 22 or 23, wherein the sub-batches are assigned to different processors for calculating said solutions.

25. A method according to any one of the preceding claims, wherein at least one of said defined functions comprises an exotic betting function.

26. A method according to any one of the preceding claims wherein said received orders represent a mixture of different classes of bets which are processed together to obtain solutions for said coefficients simultaneously.

27. A method according to any one of claims 1 to 12, wherein said outcomes defined for said event are mutually exclusive, and the or each said at least one function takes on one value for one specified outcome and one common other value for all other outcomes.

28. A method according to claim 27, wherein the or each said at least one defined function comprises a fixed-odds betting function.

29. A method according to claim 27 or 28, comprising dividing the received orders into sub-batches defined in terms of orders for bets on one or more participants in said event.

30. A method according to claim 27 or 28, wherein said step of calculating a solution comprises imposing a rank on received orders which reflects the market demand for bets on different participants.

31. A system comprising:
event specification means for specifying an event;
outcome defining means for defining a set of outcomes for said event;
transaction function defining means for defining at least one function representing a transaction between an exchange and another party, said at least one function being dependent on the outcome of said event;
communication apparatus for receiving, at said exchange, orders for at least one said transaction from at least one other party;
processing means for applying a map between the space generated by the or each at least one function and the space defined by coefficients representing the proportion to which each received order is to be accepted; and
calculation means for calculating a solution for the values of said coefficients, using said map, subject to a defined constraint and an optimization criterion.

32. A system according to claim 31, wherein said calculation means further comprises a module for constructing a target function, with respect to which said coefficient values are optimized, said target function being constructed in real time based on the current orders being processed.

33. A system according to claim 31 or 32, wherein said optimization criterion comprises obtaining the maximum expected revenue for the exchange.

34. A system according to claim 33, wherein said expected revenue is defined as the market value of the orders held by the exchange.

35. A system according to claim 34, wherein said expected revenue is defined in terms of a probability measure on said set of outcomes.

36. A system according to any one claims 31 to 35, wherein said at least one optimization criterion comprises maximizing the volume of accepted orders.

37. A system according to any one claims 31 to 36, wherein said constraint comprises a hedging condition representing the maximum risk to which the exchange is to be exposed.

38. A system according to claim 37, wherein said hedging condition is that the maximum potential loss by the exchange is less than a predetermined amount, and preferably less than zero.

39. A system according to any one of claims 31 to 38, further comprising a module for representing said map in terms of a matrix.

40. A system according to any one of claims 31 to 39, further comprising input means for specifying which of the possible outcomes of the event has occurred.

41. A system according to claim 40, wherein said input means is adapted to receive data from an online web site specifying which of the possible outcomes of the event has occurred.

42. A system according to any one of claims 31 to 41, wherein said orders are received by said communication apparatus at said exchange via the Internet or other telecommunications network, and further comprising memory for storing said orders formed into one or more order batches for storage and processing.

43. A system according to any one claims 31 to 42, wherein a said at least one defined function comprises a spread bet function.

44. A system according to claim 42, wherein said calculation means comprises a module for decomposing the functions represented by the received orders into 1-dimensional groups each representing bets on one particular participant in said event.

45. A system according to claim 43, wherein said calculation means comprises a module for imposing a rank on received orders which reflects the market demand for bets on different participants.

46. A system according to claim 43 or 45, wherein said calculation means comprises a module for applying a condition that the holdings by the exchange in orders for a specified sub-set of participants must be greater than for any of the other participants.

47. A system according to claim 45 or 46, comprising:
said calculation means which calculates a solution for the values of the coefficients for acceptance of the received orders;
order removal means for removing the orders with non-zero coefficients; and
repetition means for causing said calculation means to repeat the calculation of a solution for the coefficients of the remaining orders.

48. A system according to claim 47, further comprising iteration means for causing said calculation means and removal means to operate iteratively at least once.

49. A system according to claim 47 or 48, comprising new order addition means for adding new orders to be processed along with the previously unaccepted orders, prior to causing said calculation means repeating the calculation of a solution for the coefficients.

50. A system according to any one of claims 43 to 49, comprising:
selection means for selecting from the received orders, the most competitive order for a bet on each participant, both on the buy and sell side;
submission means for submitting only the selected orders to said step of calculating a solution;
order removal means for removing orders with non-zero coefficients;
iteration means for repeating the selecting, submitting and removing steps iteratively.

51. A system according to claim 50, further comprising new order addition means for adding new orders prior to the or each operation of said selecting means.

52. A system according to any one of claims 43 to 51, comprising:
division means for dividing the received orders into sub-batches;
parallel processors for processing the sub-batches in parallel, each according to the system of any one of claims 43 to 51, to obtain solutions for the values of the coefficients of acceptance for each order in each sub-batch.

53. A system according to claim 52, wherein the sub-batches are defined in terms of orders for bets on one or more participants in said event.

54. A system according to claim 52 or 53, wherein the sub-batches are assigned to different ones of the parallel processors for calculating said solutions.

55. A system according to any one of claims 31 to 54, wherein at least one of said defined functions comprises an exotic betting function.

56. A system according to any one of claims 31 to 55, wherein said received orders represent a mixture of different classes of bets which are processed together to obtain solutions for said coefficients simultaneously.

57. A system according to any one of claims 31 to 42, wherein said outcomes defined for said event are mutually exclusive, and the or each said at least one function takes on one value for one specified outcome and one common other value for all other outcomes.

58. A system according to claim 57, wherein a said at least one defined function comprises a fixed-odds betting function.

59. A system according to claim 57 or 58, comprising a module for dividing the received orders into sub-batches defined in terms of orders for bets on one or more participants in said event.

60. A system according to claim 57 or 58, wherein said calculation means comprises a module for imposing a rank on received orders which reflects the market demand for bets on different participants.

61. A computer terminal comprising:
communication means for receiving the results of multiplying the coefficients, obtained by the method of any one of claims 1 to 30, by the respective defined function evaluated for the actual outcome of the event; and
a device for triggering transfer of financial resources corresponding to said received results in accordance with the transaction between the exchange and the at least one other party.

62. A computer program which is capable, when executed by computer processing means, of causing a computer processing means to perform a method according to any one of claims 1 to 30.

63. A computer-readable storage medium having recorded thereon a computer program according to claim 62.
